(19) United States
(12) Patent Application Publication
(10) Pub. No.: US 2026/0291161 A1
(43) Pub. Date: Sep. 24, 2026

(54) Ozone-Based DUV Laser Power Attenuation

(71) Applicant: KLA Corporation, Milpitas, CA (US)

(72) Inventors: Kristian Dehne, San Jose, CA (US); Mandar Paranjape, San Jose, CA (US); Nadine Asenbaum-Doerre, Wien (AT)

(73) Assignee: KLA Corporation, Milpitas, CA (US)

(21) Appl. No.: 19/457,710

(22) Filed: Jan. 23, 2026

Related U.S. Application Data
(60) Provisional application No. 63/757,337, filed on Feb. 12, 2025.

(51) Int. Cl. H01S 3/10; B01J 19/12; C01B 13/11; H01S 3/00

(52) U.S. Cl. CPC H01S 3/10038; H01S 3/0014; B01J 19/123; B01J 2219/00186; C01B 13/11; C01B 2201/90

(57) ABSTRACT

An ozone-based attenuation apparatus utilizes an attenuation gas mixture contained in a sealed chamber to attenuate DUV light in a DUV optical system. DUV light having an initial power level is directed by a source through an uncoated input window into the sealed chamber. A variable gas generator is utilized to control (e.g., increase/decrease) the amount of attenuation applied to the DUV light as it passes through the sealed chamber by varying (e.g., increasing/decreasing) the concentration of ozone gas included in the attenuation gas mixture. A controller utilizes the measured power level to control the variable gas generator such that the DUV light emerging from the sealed chamber by way of uncoated output window has a target (user-selected) power level. The attenuation gas mixture may include non-reactive gases (e.g., helium) to control the sealed chamber's temperature. The attenuation gas mixture in the sealed chamber is continuously purged and replaced.

### RELATED APPLICATIONS/PATENTS

This application claims priority from U.S. Provisional Patent Application No. 63/757,337, entitled “Method and Apparatus for Attenuating DUV Laser Power Through Absorption in Ozone Gas”, which was filed on Feb. 12, 2025.

### FIELD OF THE INVENTION

This invention relates to deep-ultraviolet (DUV) lasers and, more particularly, to a method and apparatus for attenuating a DUV light beam's power level. This invention also relates to high power DUV optical systems and inspection tools that implement the method/apparatus.

### BACKGROUND OF THE INVENTION

Wafer inspection and metrology tools utilize optical and sensor technologies to identify and classify particle and pattern defects that occur during semiconductor fabrication processes. Each new device design requires the development of a corresponding fabrication process capable of producing corresponding chips (physical circuit devices that implement the new circuit design) with minimal defects. In this context, semiconductor manufacturing engineers utilize wafer inspection and metrology tools to detect, resolve and monitor critical yield excursions at each fabrication stage, resulting in faster yield ramps and higher production yields, thereby maximizing the profitability of the new circuit design.

As semiconductor fabrication technology nodes continue to decrease there is corresponding demand for inspection and metrology tools capable of reliably measuring ever-smaller feature sizes and detecting ever-smaller defects. To meet this demand for new devices fabricated using cutting-edge nano-scale technology nodes, inspection and metrology tools utilize deep ultraviolet-based (DUV-based) optical systems that are capable of measuring and detecting features/defects on the wafer surface that have sizes in the sub-100 nanometer (nm) range. DUV-based optical systems typically include a DUV laser light source, illumination optics and collection optics. A DUV laser light beam generated by the source is focused and directed by the illumination optics onto a targeted region of a wafer (sample). The incident DUV light is scattered from defects located in the targeted region, and the resulting DUV light scattered from the targeted region is collected by collection optics and focused on an array of light sensitive elements (e.g., a charge-coupled device or other sensor). The signal strength at the detector is proportional to the intensity of the scattered light signal from the wafer surface in the targeted region, which increases for decreasing wavelength. Data generated by the sensor is then analyzed using various techniques, for example, to determine if the targeted wafer region includes defects that are larger than a predetermined noise-level (insignificant) size. This process is typically repeated to scan the entire wafer surface (e.g., by moving the wafer) and is performed after each stage of the fabrication process. The resulting data is then utilized as mentioned above to optimize the corresponding fabrication process.

DUV-based optical systems typically utilize one or more attenuating apparatuses to precisely control a DUV laser beam's power level. The system's DUV laser light source typically generates DUV laser beam at a single initial (relatively high) power level that must be attenuated (reduced) for some use cases before being applied to a sample to prevent surface ablation and/or to optimize a selected inspection or metrology operation. To this end, attenuating apparatuses are positioned between the DUV laser source and a targeted sample, and block/redirect a controllable portion of the laser light such that the beam's power level is set to a user-defined power level at the targeted sample. Ideally, an attenuation device provides a user with fine DUV laser beam power level control that is adjustable over a large dynamic range (i.e., between a minimum attenuation setting at which the laser light reaching a sample is substantially equal to its initial power level, and a maximum attenuation setting at which all or substantially all of the laser light is blocked/redirected). Conventional attenuation approaches typically utilize one or more motor controlled optical elements that are physically adjusted to control the amount of light transmitted or reflected from the DUV laser beam's path. In some cases these optical elements include a waveplate that is rotated to change the polarization direction of the DUV laser light and an analyzer that transmits or reflects light only in one polarization direction. Further attenuation may be achieved by passing the DUV laser beam through one or more specially coated (absorptive or reflective) windows that respectively transmit a corresponding percentage of the DUV laser beam.

Conventional attenuation apparatuses are problematic in that they are expensive to implement and maintain, and they require optics that undesirably degrade the DUV laser light reaching a targeted sample. For example, the optics utilized by polarization dependent attenuation apparatuses require special multi-layer coatings that greatly increase their cost. Moreover, the constant exposure to DUV laser light during operation increases the risk of damage to the optical elements, especially coated optical elements, which can result in transmission decreases (i.e., undesirable changes to the transmitted DUV laser light beam) and requires periodic replacement that further drives up the overall cost of the DUV optical system. In addition, the motorized mechanical assemblies utilized to adjust the optical elements may require time consuming alignment to achieve the required attenuated power level as well as high costs of repair or replacement. By utilizing optical elements constantly exposed to high-power DUV laser light and associated motorized mechanical assemblies, such conventional attenuation apparatuses for high-power DUV optical systems can cost upwards of $30,000 to install and even more to maintain.

What is needed is an attenuation apparatus/method for high power DUV optical systems used, for example, by wafer inspection and metrology tools, that is capable of precisely attenuating/changing a DUV laser light beam's power level in a reliably repeatable manner and is less expensive to install and maintain (i.e., in comparison to the conventional approaches mentioned above).

### SUMMARY OF THE INVENTION

The present invention is directed to a gas-based attenuation approach in which absorption of a DUV light beam by ozone gas molecules is utilized to attenuate the beam for use in high power DUV optical systems. The attenuation gas mixture contains a concentration of ozone gas molecules, which may be generated from a feed gas (clean dry air or pure O₂) then mixed with a neutral buffer gas (e.g., helium) before being supplied to a volume (e.g., a sealed chamber). A DUV light beam, generated by a suitable DUV laser light source, is directed through the volume/sealed chamber to a designated target (e.g., a sample mounted on a movable stage or X-Y table). Because the DUV light beam passes through the volume/sealed chamber, an intermediate section of the DUV light beam (i.e., the portion of the DUV light beam located inside the volume) necessarily intersects (impinges upon) at least some of the ozone gas molecules contained in the attenuation gas mixture. Because ozone gas molecules have a high absorption cross section in the DUV range, at least some of these intersections result in beam/ozone interactions including photolysis during which a portion of the beam's energy is expended to break the intersected ozone molecule into its oxygen components, whereby each beam/ozone interaction causes a corresponding incremental attenuation (reduction) in the beam's power level. The inventors have determined that, when the amount of ozone gas in the volume is maintained at a substantially constant concentration level, the total attenuation produced by the beam/ozone interactions is reliably repeatable (i.e., the attenuated “final” DUV light beam section exiting the ozone-gas-containing volume maintains a substantially constant power level). Moreover, the inventors determined that precise and reliable control over the attenuation amount (i.e., the amount by which the DUV laser light beam's power level is reduced from an initial power level before entering the volume to a final power level exiting the volume) is achievable by controllably changing the ozone concentration level of the attenuation gas mixture disposed within the volume. That is, the attenuation amount can be increased (i.e., the beam's final power level decreased) by way of increasing the concentration of ozone gas molecules in the volume, thereby increasing the average number of ozone/beam interactions that occur between the beam's source and a designated target. Conversely the attenuation amount can be decreased (i.e., the beam's final power level increased) by way of decreasing the concentration of ozone gas molecules in the volume, thereby decreasing the average number of ozone/beam interactions that occur between the beam's source and a designated target. Furthermore, because the ability to generate ozone gas in variable concentrations is well known and can be implemented using inexpensive and reliable commercially available apparatuses, the ozone-based attenuation approach of the present invention facilitates precisely attenuating/changing a high-power DUV laser light beam's power level in a reliably repeatable manner that is less expensive to install and maintain (i.e., in comparison to the conventional approaches mentioned above).

In one embodiment the ozone-based attenuation approach is implemented by an ozone-based attenuation apparatus including a containment structure and an attenuation gas generation unit. The containment structure includes a peripheral wall and two optical windows (i.e., an input window and an output window) that collectively surround a sealed chamber (volume), and the attenuation gas generation unit is configured to generate an attenuation gas mixture including ozone gas molecules and at least one buffer/non-attenuating gas (e.g., nitrogen (N₂) and/or helium (He)) and to supply the attenuation gas mixture into the sealed chamber (e.g., by way of a gas inlet port). During operation, the containment structure is operably positioned to receive the DUV laser beam (e.g., between a high-power DUV laser light source and a targeted sample) such that an initial section of the DUV laser beam is directed onto the input window, an intermediate section of the DUV laser beam passes through the sealed chamber between the input window and the output window, and a final section of the DUV laser beam is directed from the output window, for example, to the targeted sample. With this arrangement, an intermediate power level of the intermediate DUV laser beam section is gradually reduced by successive interactions with ozone gas molecules of the attenuation gas mixture as the intermediate DUV laser beam section passes through the sealed chamber, whereby the final laser power level of the final DUV laser beam section exiting the apparatus is lower than the initial laser power level of the initial DUV laser beam section. That is, the power level of the DUV laser beam is reduced by an attenuation amount that is directly proportional to the number of beam/ozone interactions that occur inside the sealed chamber, and the number of beam/ozone interactions is proportional to the concentration of ozone gas molecules in the attenuation gas mixture supplied by the attenuation gas generation unit into the sealed chamber. Accordingly, the ozone-based attenuation apparatus provides several advantages over convention (e.g., polarization dependent) attenuation schemes. For example, the ozone-based attenuation apparatus is substantially less expensive to produce, install and maintain because it avoids the need for mechanical moving parts (e.g., the motorized mechanical assemblies required by convention polarization dependent attenuation schemes to position/orient the various optical elements) and because alignment of the ozone-based attenuation apparatus with a DUV laser light source is greatly simplified over that required by convention attenuation schemes (i.e., because the DUV laser light beam only needs to be directed through the input/output windows). In addition, the optical windows can be implemented by a suitable uncoated material (e.g., CaF₂) because they only function to transmit the DUV laser light beam through the sealed chamber (i.e., they are not needed to attenuate the beam), thereby avoiding laser-induced optical coating damage and the associated transmission decreases and maintenance costs. Further, maintenance costs are further reduced and operation reliability increased because the ozone serves to clean the inside surfaces of the containment structure during operation. Other advantages associated with additional features of the ozone-based attenuation apparatus/method are mentioned below.

In some embodiments the peripheral wall of the containment structure includes an elongated hollow body (e.g., a tube having a circular or square cross-section) with the input window and output window connected by way of respective mounting structures at opposite ends of the elongated hollow body. Utilizing an elongated hollow body having a length that is greater than its diameter/width minimizes the amount of attenuation gas mixture required to fill the sealed chamber while maximizing the potential number of beam/ozone interactions. In some embodiments the inlet port and the outlet port are respectively located near the opposite ends of the elongated hollow body such that the supplied attenuation gas mixture flows substantially the entire length of the elongated hollow body, thereby facilitating reliable and efficient replacement of the attenuation gas mixture located inside the sealed chamber, which allows the ozone-based attenuation apparatus to quickly adjust the attenuation amount by way of rapidly changing the ozone concentration of the attenuation gas mixture located inside the sealed chamber.

In some embodiments the containment structure is made robust by being constructed using materials that do not react to ozone. In an exemplary embodiment the elongated hollow body is a 316L stainless steel tube and both the input window and the output window are Calcium Fluoride (CaF₂), whereby the containment structure is both resistant to ozone damage, and the supplied ozone serves to clean the inside surfaces of the sealed chamber. In some embodiments, non-reactive window gaskets (e.g., perfluorinated O-rings) are respectively sandwiched between peripheral edges of the input and output windows and corresponding flanges provided in the mounting structures to prevent the undesirable leakage of ozone from the sealed chamber.

In some embodiments the input and output windows are uncoated CaF₂ and maintained at a Brewster angle relative to the DUV light beam. In addition to the reduced maintenance and improved beam quality provided by using uncoated CaF₂, maintaining the input and output windows the Brewster angle minimize Fresnel losses, which maximizes transmission when no laser power attenuation is desired. Therefore, this attenuator approach has minimal impact on the total transmission of the overall optical system within which it is placed (i.e., in comparison to conventional approaches).

In alternative embodiments the attenuation gas generation unit may produce attenuation gas mixture having a specified ozone concentration using either a commercially sourced variable ozone generator or a custom-built variable ozone generator. In some embodiments the variable ozone generator utilizes a feed gas input mechanism to provide stable oxygen gas molecules (e.g., either from clean dry air (CDA) or pure oxygen gas) to an ozone generation device and utilizes the ozone generation device to convert the stable oxygen gas molecules into ozone gas molecules using known techniques (e.g., UV discharge or corona discharge). In some embodiments the attenuation gas generation unit is controlled to produce the attenuation gas mixture with a specified ozone concentration by controlling the feed gas input mechanism (e.g., to increase/decrease the amount of stable oxygen gas supplied to the ozone generation device). In other embodiments an operating state of the ozone generation device is controlled to increase/decrease the amount of stable oxygen gas molecules converted into ozone gas molecules (e.g., in the case of a UV discharge-type ozone generator, the amount of oxygen-to-ozone conversion can be increased/decreased by way of increasing/decreasing the operating state (intensity) of the generator's UV lamp).

In some embodiments the attenuation gas generation unit mixes the ozone-containing gas mixture component generated by the variable ozone generator with a secondary gas component containing one or more neutral gases (e.g., N₂ and/or He₄). The addition of an inert buffer gas (e.g., helium) with high thermal conductivity and low density helps to minimize thermal effects, generated by the interaction of the DUV light beam with the gas mixture, which negatively impact the attenuated beam quality. This also allows for higher flow rates through the sealed volume without impacting beam stability or increasing the flow rate into the ozone generator (which negatively impacts generator performance). The higher flow further aids attenuator performance by rapid evacuation and replenishment of ozone molecules to the volume.

In some embodiments the ozone-based attenuation apparatus includes an ozone destruct catalyst unit that is attached to the outlet port of the containment structure and functions to remove residual ozone gas molecules from the attenuation gas mixture portion as it exits the sealed chamber, thereby preventing residual ozone from damaging external surfaces. In some embodiments an ozone detector is utilized to verify that the residual ozone has been neutralized (e.g., converted to stable oxygen) or otherwise removed from any exhaust gas exiting the apparatus.

In another embodiment a DUV optical system includes a DUV laser light source, at least one ozone-based attenuation apparatus, at least one sensor and a controller that are collectively configured to direct a DUV laser light beam onto a targeted sample at an optimized power level. The DUV laser light source is configured to direct an initial DUV laser light beam section having an initial, relatively high laser power level onto the ozone-based attenuation apparatus. The ozone-based attenuation apparatus includes a containment structure and an attenuation gas generation unit including a variable ozone generator. The containment structure is configured and functions substantially as described above. The variable ozone generator, which may form part or all of the attenuation gas generation unit, utilizes known techniques to control (selectively vary) the ozone concentration of an attenuation gas mixture that is supplied into the sealed chamber of the containment structure. The sensor(s) is/are positioned and configured to measure a laser power level of the DUV laser beam exiting the sealed chamber, and to generate a corresponding measured power level value. The controller is configured to utilize the measured power level to control (i.e., maintain, increase or decrease) the concentration (amount) of ozone gas molecules of the attenuation gas mixture generated by the attenuation gas generation unit and supplied into the sealed chamber, thereby controlling the amount by which the intermediate DUV laser light beam section is attenuated as it passes through the sealed chamber such that the laser power level of the DUV laser beam exiting the sealed chamber achieves (i.e., is maintained at or biased toward) a predetermined optimal power level. In an exemplary embodiment, the sensor generates and transmits a sensor signal including the measured power level value to the controller, and the controller compares the measured power level value with a targeted (i.e., user-defined or otherwise predetermined) power level value, which is supplied from a user or other external source and stored in a memory circuit that is accessible by the controller. The controller then generates a corresponding control signal including a control value that is based on a difference between the measured power level value and the targeted power level value and transmits the corresponding control signal to the variable ozone generator, thereby controlling the variable ozone generator to generate ozone gas molecules at a rate (in an amount) that corresponds to the control value. The ozone gas molecules generated by the variable ozone generator are utilized to generate the attenuation gas mixture having the ozone concentration that, when supplied to the containment structure, produces the required amount of DUV laser light attenuation. For example, when the measured power level value is greater than the targeted power level value, the controller generates and transmits a corresponding control signal that changes the operating state of the variable ozone generator such that it increases the generated amount of ozone gas molecules, whereby the attenuation gas generation unit the attenuation gas mixture supplied into the sealed chamber has an increased ozone concentration, thereby biasing the laser power level of the DUV laser beam exiting the sealed chamber toward the predetermined optimal power level (i.e., by increasing the attenuation amount by which the attenuation apparatus reduces the laser power level of the DUV laser beam exiting the sealed chamber). Conversely, when the measured power level value is less than the targeted power level value, the controller changes the operating state of the variable ozone generator such that the corresponding gas mixture has a relatively low (decreased) ozone gas concentration, thereby biasing the resulting laser power level toward the predetermined optimal power level by decreasing the amount by which the DUV laser beam is attenuated. When the measured power level value detected by the sensor equals the targeted power level value, the controller controls the variable ozone generator to maintain the corresponding current ozone generation rate (e.g., the control signal either maintains the current control value or is deactivated). In addition to the advantages mentioned above with reference to the ozone-based attenuation apparatus, the use of a variable ozone generator to control the ozone concentration allows the DUV optical system to achieve a predetermined optimal power level under a wide range of operating conditions (e.g., in response to changes in the initial power level of DUV light generated by the DUV laser light source).

In some embodiments an ozone-based attenuation apparatus may include multiple containment structures arranged in series along the optical path of a DUV light beam and may utilize multiple attenuation gas generation units to separately control the ozone concentration in each of the multiple containment structures. This configuration may increase the total dynamic attenuation range and provide more precise power level control (i.e., compared to a single containment structure configuration), and may also be used to reduce the apparatus' length.

In other embodiments the invention pertains to an inspection or metrology tool that implements a DUV laser-based illumination optical system including one or more ozone-based attenuation apparatuses of the type described herein.

### BRIEF DESCRIPTION OF THE DRAWINGS

The above-mentioned embodiments and other features, aspects and advantages of the present invention will become better understood with regard to the following description, appended claims, and accompanying drawings, where:

FIG. 1 is a simplified diagram depicting a DUV optical system including an ozone-based attenuator apparatus according to an embodiment of the present invention;

FIGS. 2A and 2B are diagrams depicting a volume containing attenuation gases having a relatively high ozone concentration and having a relatively low ozone concentration, respectively, where the volume is located inside a containment structure of the attenuator apparatus of FIG. 1;

FIG. 3 is a perspective view showing a containment structure of an ozone-based attenuator apparatus according to another embodiment;

FIG. 4 is a diagram depicting a DUV optical system including the ozone-based attenuator apparatus of FIG. 3 according to another embodiment of the present invention;

FIG. 5 is a chart depicting experimental data showing attenuation versus ozone concentration using an attenuation gas mixture comprising clean dry air;

FIG. 6 is a chart depicting experimental data showing attenuation versus ozone concentration using an attenuation gas mixture comprising helium and/or clean dry air; and

FIG. 7 is a diagram depicting an ozone-based attenuator apparatus according to another embodiment of the present invention.

### DETAILED DESCRIPTION OF THE DRAWINGS

The present invention relates to ozone-based DUV laser power attenuation. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described but is to be accorded the widest scope consistent with the principles and novel features herein disclosed.

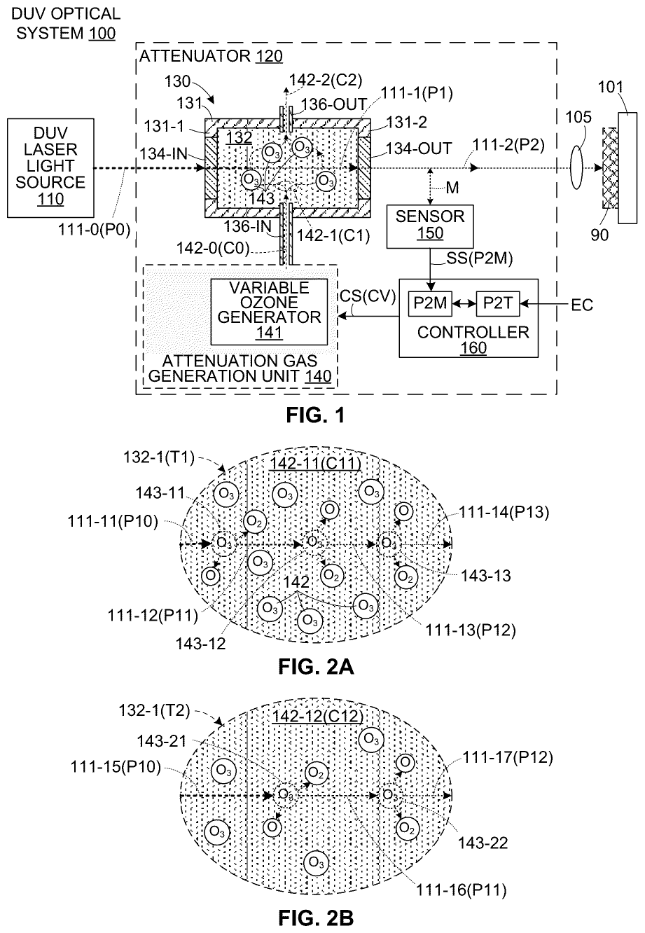

FIG. 1 shows a DUV optical system 100 including a DUV laser light source 110, an ozone-based attenuation apparatus 120, a sensor 150 and a controller 160 according to an exemplary embodiment.

DUV laser light source 110 is configured to generate a DUV light beam using known techniques. DUV laser light source 110 may be implemented using a commercially available laser (e.g., an excimer laser, a frequency-multiplied solid-state laser, or a gas laser) that is capable of generating DUV light beam 111-0 at a suitable DUV wavelength (i.e., generally in the range of 10 nm to 300 nm, and more commonly in the range of approximately 190 nm to approximately 250 nm).

For purposes of explaining ozone-based attenuation, the DUV light beam generated by DUV laser light source 110 is described with reference to three sections: an initial DUV light beam section 111-0, an intermediate DUV light beam section 111-1 and a final DUV light beam section 111-2. Initial DUV light beam section 111-0 includes a portion of the DUV light beam extending between DUV laser light source 110 and ozone-based attenuation apparatus 120 and is generated by DUV laser light source 110 with an initial power level P0 and is directed along an optical path (indicated by dotted-line arrow). Intermediate DUV light beam section 111-1 includes a portion of the DUV light beam extending through ozone-based attenuation apparatus 120 and has an intermediate power level P1 that is described below. Final DUV laser beam section 111-2 includes a portion of the DUV light beam extending from ozone-based attenuation apparatus 120 and has a final power level P2.

Ozone-based attenuation apparatus 120 includes a containment structure 130 having a sealed chamber (volume) 132 and an attenuation gas generation unit 140 that is configured to generate an attenuation gas mixture including ozone gas molecules and to supply attenuation gas mixture into sealed chamber 132. In some embodiments attenuation gas generation unit 140 includes a variable ozone generator 141. In some embodiments, ozone-based attenuation apparatus 120 may include one or both of sensor 150 and controller 160. In other embodiments, sensor 150 and/or controller 160 may be part of system 100 and configured to interact with attenuator apparatus 120 as described below.

Containment structure 130 includes a peripheral wall 131, an input window 134-IN and an output window 134-OUT that collectively substantially surround (enclose) sealed chamber 132. In some embodiments peripheral wall 131 comprises a rigid (e.g., metal) frame to which input window 134-IN and output window 134-OUT are fixedly connected. Input window 134-IN and output window 134-OUT comprise a material that is substantially optically transparent to DUV light (e.g., Calcium Fluoride (CaF₂)). Input window 134-IN and output window 134-OUT are located on opposing portions of containment structure 130 (i.e., input window 134-IN is located on and fixedly connected to a first end wall portion 131-1 of peripheral wall 131 and the output window 134-OUT is located on and fixedly connected to a second (opposing) end wall portion 131-2) to facilitate transmission of intermediate beam portion 111-1 through at least a portion of sealed chamber 132. In other embodiments, peripheral wall 131, input window 134-IN and output window 134-OUT may comprise an integral shell-type structure comprising a material that is substantially optically transparent to DUV light. Containment structure 130 also includes an inlet port 136-IN and an outlet port 136-OUT that respectively provide inlet and outlet openings through peripheral wall 131 by which an attenuation gas mixture may be supplied into sealed chamber 132.

Attenuation gas generation unit 140 is configured to generate an attenuation gas mixture including ozone gas molecules at an initial concentration and to supply the attenuation gas mixture into the sealed chamber 132 (e.g., by way of an inlet port 136-IN). For purposes of describing changes to the ozone concentration of the attenuation gas mixture during operation, the portion of attenuation gas mixture supplied by attenuation gas generation unit 140 to containment structure 130 is referred to as initial gas mixture portion 142-0 having an initial ozone concentration C0, the attenuation gas mixture portion located inside sealed chamber 132 is referred to as intermediate gas mixture portion 142-1 having an intermediate ozone concentration C1, and the attenuation gas mixture portion exiting sealed chamber 132 (e.g., by way of an outlet port 136-OUT) is referred to as final gas mixture portion 142-2 having a final ozone concentration C2. As illustrated by intermediate gas mixture portion 142-1 located inside sealed chamber 132, the attenuation gas mixture generated by attenuation gas generation unit 140 includes ozone gas molecules 143 (O₃) mixed with at least one additional neutral (buffer) gas (e.g., gases such as nitrogen (N₂) and/or helium (He₄) that do not interact with DUV light in the manner described herein with reference to ozone). In some embodiments, variable ozone generator 141 utilizes known techniques to generate the ozone gas molecules included in initial gas mixture portion 142-0. In some embodiments, attenuation gas generation unit 140 supplies initial gas mixture portion 142-0 at a positive gas pressure into sealed chamber 132 by way of inlet port 136-IN such that the resulting pressure pushes intermediate gas mixture portion 142-1 away from inlet port 136-IN and toward outlet port 136-OUT and final gas mixture portion 142-2 is pushed out of sealed chamber 132 by way of outlet port 136-OUT, thereby facilitating rapid adjustments to intermediate ozone concentration C2 of intermediate gas mixture portion 142-1 inside sealed chamber 132, which in turn facilitates rapid adjustment in the amount of attenuation to intermediate DUV laser beam section 111-1.

During operation of DUV optical system 100, ozone-based attenuation apparatus 120 is positioned relative to DUV laser light source 110 such that DUV laser beam is directed through sealed chamber 132 (e.g., between input window 134-IN and an output window 134-OUT), and attenuation gas generation unit 140 is actuated to supply attenuation gas mixture 142-0 to containment structure 130. According to an aspect, intermediate DUV laser beam section 111-1 is attenuated by interaction with at least some of the ozone gas molecules located inside sealed chamber 132 such that final laser power level P2 of final DUV laser beam section 111-2 is lower than initial laser power level P0 of initial DUV laser beam section 111-0, and such that each beam/ozone interaction incrementally reduces the number of ozone gas molecules in sealed chamber 132. By way of example, FIG. 2A depicts sealed chamber 132 at a time T1 in which it contains an intermediate attenuation gas mixture portion 142-11 and through which a portion of intermediate DUV light beam section 111-1 is directed. For descriptive purposes, the portion of intermediate DUV light beam section 111-1 passing through sealed chamber 132 is divided into a first segment 111-11 having power level P10, a second segment 111-12 having power level P11, a third segment 111-13 having power level P13 and a fourth segment 111-14 having power level P14. Referring to the left side of FIG. 2A, a first beam/ozone interaction occurs when first DUV light beam segment 111-11 intersects (impinges upon) ozone gas molecule 143-11 and is depicted by the photolysis of ozone gas molecule 143-11 (e.g., the chemical decomposition of O₃ into its oxygen components O₂ and O). This beam/ozone interaction occurs due to the high absorption cross section of ozone gas molecule 143-11, and results both in an incremental reduction in the power level of intermediate DUV light beam section 111-1 (i.e., power level P11 of second DUV light beam segment 111-12 is incrementally attenuated (reduced) from power level P10 of first segment 111-11) and an incremental reduction in the concentration of ozone gas molecules inside sealed chamber 132 (i.e., due to the dissociation of ozone gas molecule 143-11). Note that each beam/ozone interaction also causes other changes in attenuation gas mixture portion 142-11, such as scattering and thermal effects, but these additional interactions are omitted from the description of FIG. 2A for brevity. Referring to the center of FIG. 2A, the subsequent intersection of second DUV light beam segment 111-12 with ozone gas molecule 143-12 results in a second beam/ozone interaction such that power level P13 of third segment 111-13 is incrementally lower than power level P12, and the subsequent intersection of third DUV light beam segment 111-13 with ozone gas molecule 143-13 results in a third beam/ozone interaction, whereby power level P14 of fourth segment 111-13 is incrementally lower than power level P13. Referring again to FIG. 1, in this manner intermediate DUV laser beam section 111-1 is attenuated by interaction with at least some of the ozone gas molecules located inside sealed chamber 132 such that final laser power level P2 of final DUV laser beam section 111-2 is lower than initial laser power level P0 of initial DUV laser beam section 111-0 by an attenuation amount that can be expressed as P2-P0 (i.e., the difference between final power level P2 and initial power level P0). In addition, due to the dissociation of ozone gas molecules caused by the beam/ozone interactions, a final concentration C2 of final attenuation gas mixture portion 142-2 exiting sealed chamber 132 through outlet port 136-OUT is lower than initial concentration C0 of initial attenuation gas mixture portion 142-0 supplied into sealed chamber 132 through inlet port 136-IN.

DUV optical system 100 generates/maintains final DUV laser beam section 111-2 at a target power level by way of controlling (i.e., maintaining, increasing or decreasing) the average number of beam/ozone interactions that occur, for example, as intermediate DUV laser beam section 111-1 passes through sealed chamber 132, thereby controlling the amount of attenuation applied by ozone-based attenuation apparatus 120 to intermediate DUV laser beam section 111-1. In the example depicted in FIG. 1, control of the attenuation amount is achieved using sensor 150, controller 160 and an externally supplied target power level. Sensor 150 is operably positioned and configured using known techniques to detect and measure (e.g., as indicated by arrow M) final laser power level P2 of final DUV light beam section 111-2, and is further configured to generate a corresponding sensor signal SS including a measured power level value P2M corresponding to final power level P2. Sensor 150 is further configured to transmit measured power level value P2M to controller 160 by way of a sensor signal SS. The target power level may be a predetermined (e.g., experimentally derived or user-define) value that is operably transmitted (e.g., by way of an external control signal EC) to controller 160 and stored as target final power level P2T in a selected memory location using known techniques. In some embodiments, attenuation gas generation unit 140 utilizes variable ozone generator 141 to generate the ozone gas molecules included in attenuation gas mixture 142-0, and the concentration (amount) of ozone gas molecules in attenuation gas mixture 142-0 varies in accordance with an operating state of variable ozone generator 141 (i.e., initial ozone concentration level C1 of attenuation gas mixture 142-0 may be increased or decreased from a current level by way of corresponding changes to the operating state of variable ozone generator 141). In other embodiments (not shown), an ozone generator may be utilized to generate ozone gas molecules at a fixed rate, and other mechanisms (e.g., varying the amount of neutral gas) may be utilized to control the ozone concentration of the attenuation gas mixture supplied to sealed chamber 132. Sensor 150 may be implemented using known sensor types, and controller 160 may be implemented using a permanently configured electronic circuit (e.g., hardwired to form hardware), a temporarily configured electronic (e.g., a processor programmed with software), or a combination of the two configurations (for example, a structured application specific integrated circuit (ASIC)). In some embodiments, controller 160 may control the operating state of variable ozone generator 141 directly (e.g., by way of control signal CS), and in other embodiments attenuation gas generation unit 140 may include a control circuit that controls the operating state of variable ozone generator 141 in response to control signal CS.

FIGS. 2A and 2B are simplified depictions showing a portion 132-1 of sealed chamber (volume) 132 at two different times and are used below to explain how DUV optical system 100 (FIG. 1) controls attenuation amount P2-P0 by way of controlling (i.e., maintaining, increasing or decreasing) the average number of beam/ozone interactions occurring within containment structure 130. Specifically, FIG. 2A depicts sealed chamber portion 132-1 at a time T1 during which intermediate gas mixture portion 142-11 has a relatively high ozone concentration, and FIG. 2B depicts sealed chamber portion 132-1 at a time T2 during which intermediate gas mixture portion 142-12 has a relatively low ozone concentration C11 (i.e., as indicated by the relatively large number of ozone gas molecules (O₃) in FIG. 2A and the relatively lower number in FIG. 2B). When controller 160 determines that the power level value P2M measured by sensor 150 immediately before time T1 is greater than targeted power level value P2T, controller 160 generates and transmits a corresponding control signal CS with a control value CV that changes the operating state of variable ozone generator 141 such that the amount of ozone gas molecules in attenuation gas mixture 140-0 supplied to sealed chamber 132 is increased. As indicated in FIG. 2A, the operating state change applied to variable ozone generator 141 causes an increase of the ozone concentration of intermediate attenuation gas mixture portion 142-11 in sealed chamber portion 132-1, resulting in relatively high ozone concentration level C11 at time T1 that causes a relatively high number of beam/ozone interactions (e.g., as explained above and depicted in FIG. 2A, the intermediate DUV light beam section experiences three beam/ozone interactions with ozone gas molecules 143-11, 143-12 and 143-13 as it passes through sealed chamber portion 132-1). The relatively high number of beam/ozone interactions results in a relatively large attenuation amount P2-P0, thereby biasing (i.e., lowering) final laser power level P2 of final DUV laser beam section 111-2 exiting sealed chamber 132 toward target final power level P2T. In contrast, when controller 160 determines that the power level value P2M measured by sensor 150 immediately before time T2 is less than targeted power level value P2T, controller 160 changes the operating state of variable ozone generator 141 to decrease the amount of ozone gas molecules in attenuation gas mixture 140-0 supplied to sealed chamber 132. The resulting decrease in the amount of ozone produces intermediate attenuation gas mixture portion 142-11 with relatively low ozone concentration level C12 in sealed chamber portion 132-1 at time T2, resulting in a relatively low number of beam/ozone interactions (e.g., as depicted in FIG. 2B, a first DUV light beam segment 111-15 having power level P10 is incrementally attenuated by interaction with ozone gas molecule 143-21 and resulting second DUV light segment 111-16 having power level P11 is incrementally attenuated by interaction with ozone gas molecule 143-22, whereby third DUV light beam segment 111-17 having power level P12 exits sealed chamber portion 132-1). Note that power level P12 of DUV light segment 111-17 (FIG. 2B) is greater than power level P13 of DUV light segment 111-17 (FIG. 2B) due to the fewer number of beam/ozone interactions, which is produced by relatively low ozone concentration level C12. Although greatly simplified, the example provided above with reference to FIGS. 2A and 2B illustrates how DUV optical system 100 may control attenuation amount P2-P0 by way of controlling (i.e., maintaining, increasing or decreasing) the average number of beam/ozone interactions occurring within containment structure 130.

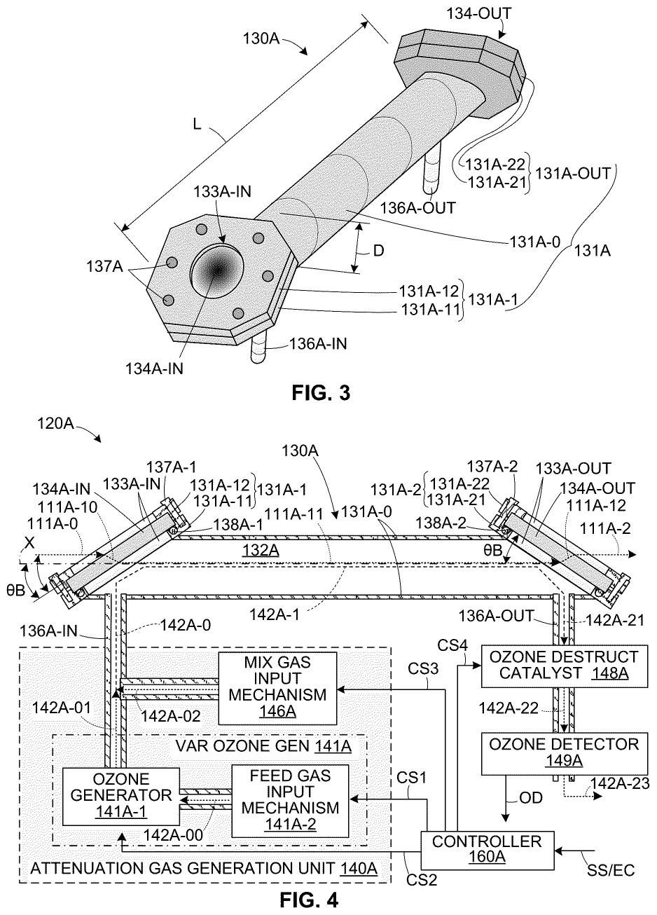

FIG. 3 is a perspective view showing a containment structure 130A according to a specific embodiment, and FIG. 4 includes a cross-sectional view of zone-based attenuator apparatus 130A. Containment structure 130A includes a peripheral wall 131A, an input window 134A-IN and an output window 134A-OUT collectively surrounding a sealed chamber 132A that is accessible by way of an inlet port 136A-IN and an outlet port 136A-OUT.

Peripheral wall 131A includes an elongated hollow body 131A-0, a first mounting structure 131A-1 located at a first end of elongated tube 131A-0 and a second mounting structure 131A-2 located at an opposing (second) end of the elongated hollow body 131A-0.

In one embodiment, elongated hollow body 131A-0 is implemented using a 316L steel tube having a longitudinal length L that is greater than its lateral diameter D. In other embodiments, elongated hollow body 131A-0 may be formed using other materials that do not react to ozone, and may be configured with an elongated structure having a non-circular cross-sectional shape (e.g., oval, square or triangular).

Mounting structures 131A-1 and 131A-2 are located at opposing ends of elongated hollow body 131A-0 and function to secure (fixedly connect) input window 134A-IN and output window 134A-OUT, respectively, to peripheral wall 131A. First mounting structure 131A-1 includes an input flange 131A-11 and an input cap 131A-12 that collectively define an input opening 133A-IN, and second mounting structure 131A-2 includes an output flange 131A-21 and an output cap 131A-22 that collectively define an output opening 133A-OUT. As indicated in FIG. 4, input flange 131A-11 is integrally welded or otherwise fixedly connected to the first end of elongated tube 131A-0 and input cap 131A-12 is connected to input flange 131A-11, for example, by way of suitable fasteners (e.g., screw 137A-1), and first mounting structure 131A-1 is configured to receive and secure input window 134A-IN such that fills (encloses) input opening 133A-IN. Similarly, output flange 131A-21 is fixedly connected to the second end of elongated tube 131A-0 and output cap 131A-22 is fastened to output flange 131A-21 (e.g., by way of screw 137A-2), and second mounting structure 131A-2 is configured to receive and secure output window 134A-OUT over output opening 133A-OUT. In some embodiments, window gaskets formed from non-reactive materials are utilized to form leak-resistant seals at locations where peripheral wall 131A contacts input window 134A-IN and output window 134A-OUT. Referring to FIG. 4, in one embodiment input flange 131A-11 includes an annular O-ring groove configured to receive a first non-reactive perfluorinated O-ring (window gasket) 138A-1 that becomes sandwiched between a peripheral edge of input window 134A-IN and input flange 131A-11 when input cap 131A-12 is operably secured (e.g., by way of fastener 137A-1). Similarly, output flange 131A-21 includes a second O-ring groove that receives a second perfluorinated O-ring 138A-2 that is sandwiched between output window 134A-IN and output flange 131A-21 when output cap 131A-22 is operably secured.

Inlet port 136-IN and outlet port 136-OUT are respectively located near opposite ends of the elongated hollow body 131A-0. As indicated in FIG. 4, inlet port 136-IN is located adjacent to first mounting structure 131A-1 and facilitates the inflow of attenuation gas mixture 142A-0 into sealed chamber 132A, and outlet port 136-OUT is located adjacent to second mounting structure 131A-2 and facilitates the outflow of attenuation gas mixture 142A-2 from sealed chamber 132A. With this arrangement, as indicated by the dashed line path in FIG. 4, intermediate attenuation gas mixture portion 142A-1 consistently flows substantially the entire length L of elongated hollow body 131A-0 between input mirror 134A-IN and output mirror 134A-OUT during operation. In some embodiments inlet port 136-IN and outlet port 136-OUT are stainless steel tube fittings that are welded onto elongated hollow body 131A-0.

FIG. 4 depicts an ozone-based attenuation apparatus 120A including containment structure 130A (described above), an attenuation gas generation unit 140A and a controller 160A. Although omitted from FIG. 4 for brevity and clarity, ozone-based attenuation apparatus 120A may also include a DUV laser light source configured to generate and direct an initial DUV light beam section 111A-0 and one or more sensors that provide sensor signals SS to controller 160A for reasons described above with reference to FIG. 1.

Referring to the upper left portion of FIG. 4, during operation containment structure 130A is positioned relative to a DUV laser light source (not shown) such that initial DUV light beam section 111A-0 is directed onto input window 134A-IN, an intermediate DUV light beam section 111A-1 passes through containment structure 130A, and a final DUV light beam section 111A-2 exits containment structure 130A by way of output window 134A-OUT. For descriptive purposes, the portion of intermediate DUV light beam section 111A-1 passing through containment structure 130A is divided into a first segment 111A-10 passing through input window 134A-IN, a second segment 111A-11 passing along (or parallel to) a longitudinal central axis X of elongated hollow body 131A-0 (i.e., between input window 134A-IN and output window 134A-OUT), and a third segment 111A-12 passing through output window 134A-OUT. As indicated in FIG. 4, containment structure 130A is further configured such that mounting structures 131A-1 and 131A-2 maintain input window 134A-IN and output window 134A-OUT at a wavelength specific Brewster angle θB relative to longitudinal central axis X. With this arrangement, when initial DUV light beam section 111A-0 is directed parallel to longitudinal central axis X, intermediate DUV light beam section 111A-10 passes through input window 134A-IN and intermediate DUV light beam section 111A-12 passes through output window 134A-OUT with minimal Fresnel losses. By way of comparison, orienting the input and output windows perpendicular to the intermediate DUV light beam section would result in an approximate 4% loss in laser power for each surface (i.e., twice for each window), whereas orienting the input and output windows as described with reference to FIG. 4 produces almost zero power loss at each surface (depending on input polarization, angle precision, alignment, etc.).

Referring to the lower left portion of FIG. 4, attenuation gas generation unit 140A is configured to generate and supply attenuation gas mixture 142A-0 to containment structure 130A in accordance with control signals received from controller 160A. In the exemplary embodiment shown in FIG. 4, attenuation gas generation unit 140A includes a variable ozone generator 141A and an optional mix gas input mechanism 146A.

Variable ozone generator 141A is controlled by controller 160A to generate at least a portion 142A-01 of attenuation gas mixture 142A-0 supplied to containment structure 130A. In the exemplary embodiment, variable ozone generator 141A includes an ozone generation device 141A-1 and a feed gas input mechanism 141A-2. Feed gas input mechanism 141A-2 is configured to generate or otherwise produce a feed gas 142A-00 (e.g., clean dry air (CDA) or purge oxygen gas) that includes stable oxygen gas molecules (O₂). Ozone generation device 141A-1 is configured to receive feed gas 142A-00 and to generate attenuation gas mixture portion 142A-01 by converting at least some of its stable oxygen gas molecules into ozone gas molecules. Controller 160A is configured to control the concentration (amount) of ozone gas molecules (O₃) contained in attenuation gas mixture portion 142A-01 by controlling at least one of feed gas input mechanism 141A-2 (using control signal CS1) and ozone generation device 141A-1 (using control signal CS2). In some embodiments, controller 160A controls attenuation gas generation unit 140A to produce attenuation gas mixture 142A-0 with a specified ozone concentration by controlling feed gas input mechanism 141A-2 (e.g., using control signal CS1) to increase/decrease the rate at which stable oxygen gas is supplied to ozone generation device 141A-1. In other embodiments controller 160A controls an operating state of ozone generation device 141A-1 (e.g., using control signal CS2) to increase/decrease the proportion of supplied stable oxygen gas molecules that are converted into ozone gas molecules. For example, when ozone generation device 141A-1 is a UV discharge-type ozone generator, the amount of oxygen-to-ozone conversion can be increased/decreased by way of increasing/decreasing the operating state (intensity) of the generator's UV lamp). In yet other embodiments controller 160A controls both ozone generation device 141A-1 and feed gas input mechanism 141A-2 in the manner described above to produce attenuation gas mixture portion 142A-01 with a specified ozone concentration. In alternative embodiments some or all of variable ozone generator 141A may be commercially sourced to minimize overall system costs or may be custom made or modified in a way that optimizes operation.

Attenuation gas generation unit 140A also includes an optional mix gas input mechanism 146A that is configured to generate a secondary gas component 142A-02 that combines with attenuation gas mixture component 142A-01 generated by variable ozone generator 141A to form attenuation gas mixture 142A-0, which is then supplied to sealed chamber 132A by way of inlet port 136A-IN. Secondary gas component 142A-02 includes at least one neutral (buffer) gas (e.g., nitrogen gas (N₂) and/or helium gas (He₄)). The volume and/or composition of secondary gas component 142A-02 generated by mix gas input mechanism 146A is controlled by controller 160A (e.g., by way of control signal CS3), thereby providing additional control over the ozone concentration of attenuation gas mixture 142A-0, and also facilitates control over the temperature inside sealed chamber 132A. That is, the beam/ozone interactions used to attenuate laser power are mostly converted into heat energy and transferred to peripheral wall 131A. To prevent potentially damaging high temperatures inside sealed chamber 132a, this heat energy may be controlled using alternate methods of construction, such as providing exterior cooling of peripheral wall 131A to aid with thermal conductivity, the use of dual or multi-chambered cells, gas recirculation, and variable interaction lengths. In one embodiment, attenuation gas generation unit 140A is utilized to control the temperature inside sealed chamber 132A by way of increasing the amount of helium gas in attenuation gas mixture 142A-0 and/or by increasing the flow rate of attenuation gas mixture 142A-0.

Referring to the lower right portion of FIG. 4, an ozone destruct catalyst unit 148A may be operably coupled to receive final attenuation gas mixture portion 142A-21 as it flows out of sealed chamber 132A through outlet port 136A-OUT and is configured to remove residual ozone gas molecules from final attenuation gas mixture portion 142A-21 (i.e., to convert the residual ozone back to O₂) using known techniques. An optional ozone detector 149A is operably coupled to receive processed final attenuation gas mixture portion 142A-22 exiting ozone destruct catalyst unit 148A and is configured to verify that the ozone concentration of processed attenuation gas mixture 142A-22 is below a minimum safe level before releasing final-final attenuation gas mixture portion 142A-23 to the surrounding atmosphere, thereby protecting users and equipment. In some embodiments, one or more additional ozone detectors could be, for example, positioned to measure the ozone concentration of attenuation gas entering the sealed chamber and utilized to provide feedback for controlling the variable ozone generator.

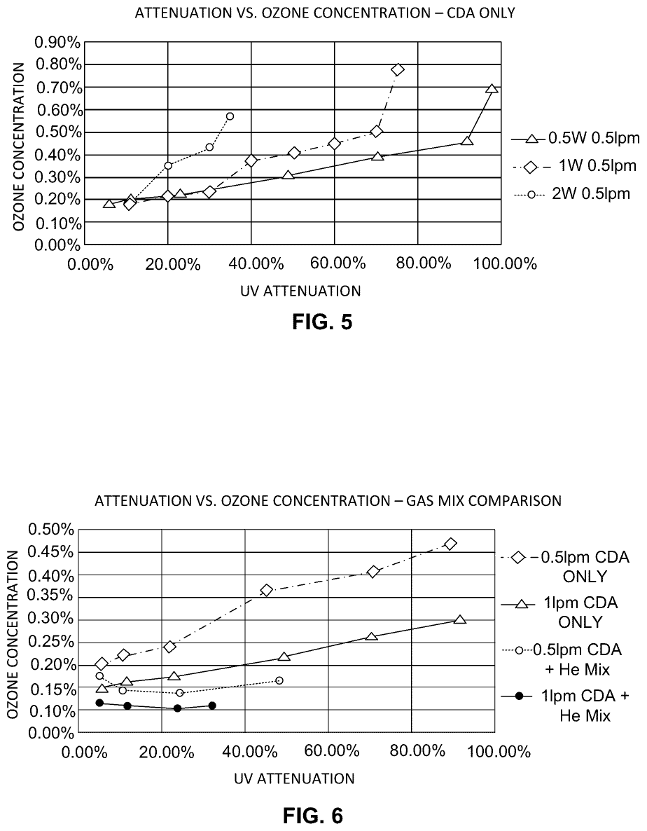

FIGS. 5 and 6 are charts depicting experimentally derived data indicating attenuation results for a series of tests performed with a prototype based on ozone-based attenuation apparatus 120A. In FIG. 5, UV power attenuation as a function of ozone gas concentration is shown for 0.5, 1, and 2W of input power. These concentrations correspond to a CDA-only feed gas flow rate of 0.5 lpm. In FIG. 6, UV power attenuation for 0.5W input power is shown as a function of ozone concentration. In this case, comparison between different flow rates and gas mixtures highlights the effect of helium gas mixture. That is, when helium gas is mixed with ozone to create an attenuation gas mixture, FIG. 6 shows that attenuation is achieved while maintaining a low concentration of ozone gas.

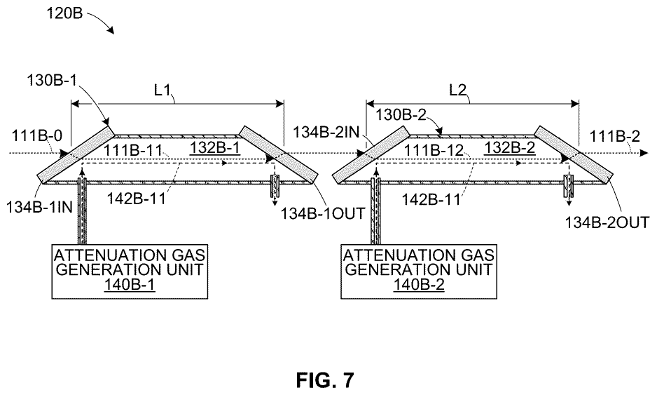

Although the ozone-based attenuation approach is described above with reference to embodiments that utilize a single containment structure and a single attenuation gas generation unit, the low cost and simplicity of the ozone-based attenuation apparatus facilitate the beneficial use of multiple containment structures and/or gas generation units while still maintaining the various benefits mentioned above. For example, FIG. 7 shows an ozone-based attenuation apparatus 120B that utilizes two series-arranged containment structures 130B-1 and 130B-2 to attenuate a DUV light beam. Although simplified for clarity and brevity, it is understood that both containment structures 130B-1 and 130B-2 are configured and operate in the manner described above with reference to containment structure 130A (see FIGS. 3 and 4). During operation attenuation gas generation unit 140B-1 supplies attenuation gas mixture 142B-1 into sealed chamber 132B-1 of containment structure 130B-1, attenuation gas generation unit 140B-2 supplies attenuation gas mixture 142B-2 into sealed chamber 132B-2 of containment structure 130B-2, and a source (not shown) directs an initial DUV light beam section 111B-0 onto an input window 134B-1IN of containment structure 130B-1. Containment structures 130B-1 and 130B-2 are arranged in series and configured such that the DUV light beam passes through sealed chamber 132B-1 as intermediate DUV light beam section 111B-11 and is directed from output window 134B-1OUT to input window 134B-2IN of containment structure 130B-2, passes through sealed chamber 132B-2 as intermediate DUV light beam section 111B-12, and then emerges from output window 134B-2OUT as final DUV light beam section 111B-2. By utilizing two (or more) series-arranged containment structures, apparatus 120B provides several possible advantages over the single containment structure configuration of apparatus 120A (described above). First, by forming containment structure 130B-1 with a length L1 that differs from a length L2 of containment structure 130B-2, apparatus 120B may increase the total dynamic range of attenuation while providing more precise control over the power level of the final DUV light beam section. Second, utilizing two or more smaller containment structures in place of a single larger containment structure may address thermal and/or space constraint issues while still providing the same attenuation range of the single larger containment structure.

In other embodiments the invention pertains to an inspection or metrology tool that implements a DUV laser-based illumination optical system including one or more ozone-based attenuation apparatuses of the type described herein. The use of a DUV laser-based illumination optical system in an inspection or metrology tool will require a beam shape and intensity carefully prescribed for a particular use case. Based on the needs of this prescribed setup, an ozone-based attenuation apparatus may be inserted within the beam path in a single location or multiple positions to precisely attenuate the power level of one or more DUV light beams. For example, in an inspection tool that is configured to detect particles or defects on a sample using both normal and oblique illumination beams, a DUV optical system may be configured to split DUV light generated by a single DUV laser into two beams and to direct the two beams along normal and oblique optical paths to a sample. In this case, two ozone-based attenuation apparatuses may be utilized in parallel to precisely control the power levels of the normal and oblique beams, respectively. By varying the number of containment structures and the ozone concentration of the attenuation gas mixture supplied to each containment structure, the degree of attenuation can be precisely controlled for different use cases.

As set forth above, advantages of the present invention include relatively low cost, relatively high interaction speed, and relatively simple construction in comparison to conventional DUV attenuation approaches. Additionally, because the ozone-based attenuation apparatus uses only uncoated optical elements, the risk of laser induced damage to optical coatings is avoided. Moreover, because DUV laser light attenuation is achieved without the use of the motorized mechanical assemblies required by convention polarization-type attenuation approaches, the ozone-based attenuation apparatus is inherently reliable.

Although the present invention has been described with respect to certain specific embodiments, it will be clear to those skilled in the art that the inventive features of the present invention are applicable to other embodiments as well, all of which are intended to fall within the scope of the present invention.

1. An apparatus for attenuating a deep-ultraviolet (DUV) light beam, the apparatus comprising:
a containment structure including a peripheral wall, an input window and an output window collectively surrounding a sealed chamber; and
an attenuation gas generation unit configured to generate an attenuation gas mixture including ozone gas molecules and to supply the attenuation gas mixture into the sealed chamber,
wherein, when the DUV light beam is directed through the containment structure such that an initial section of the DUV light beam having an initial laser power level is directed onto the input window, an intermediate section of the DUV light beam passes across the sealed chamber from the input window to the output window, and a final section of the DUV laser beam having a final laser power level is directed from the output window, and
wherein an intermediate power level of the intermediate DUV light beam section is attenuated by interaction with at least some of the ozone gas molecules disposed in the sealed chamber such that the final laser power level is lower than the initial laser power level.

2. The apparatus of claim 1, further comprising:
a sensor configured to generate a measured power level value by measuring the final laser power level of the final DUV light beam section; and
a controller configured to utilize the measured power level value to control a concentration of said ozone gas molecules in the attenuation gas mixture generated by the attenuation gas generation unit and supplied into the sealed chamber such that the laser power level of the DUV light beam exiting the sealed chamber achieves a target power level.

3. The apparatus of claim 2,
wherein the attenuation gas generation unit utilizes a variable ozone generator to generate said ozone gas molecules such that the concentration of said ozone gas molecules in the attenuation gas mixture generated by the attenuation gas generation unit varies in accordance with an operating state of thevariable ozone generator,
wherein the controller is further configured to compare the measured power level value with a targeted power level value, to generate a corresponding control signal including a control value that is based on a difference between the measured power level value and the targeted power level value, and to transmit the corresponding control signal to the attenuation gas generation unit, and
wherein the attenuation gas generation unit is further configured to control the operating state of thevariable ozone generator in accordance with the control value of the corresponding control signal such that the concentration of said ozone gas molecules in the attenuation gas mixture varies in accordance with changes in the control value.

4. The apparatus of claim 3,
wherein the containment structure further includes an inlet port and an outlet port,
wherein the apparatus is configured such that an initial portion of the attenuation gas mixture generated by the attenuation gas generation unit is supplied to the sealed chamber through an inlet port, an intermediate portion of the attenuation gas mixture flows through the sealed chamber from the inlet port to the outlet port, and a final portion of the attenuation gas mixture flows out of the sealed chamber through the outlet port, and
wherein said interaction of the intermediate DUV light beam section with at least some of the ozone gas molecules in the sealed chamber causes a reduction in the concentration of said ozone gas molecules of the intermediate attenuation gas mixture portion such that a final concentration of the final attenuation gas mixture portion exiting the sealed chamber through the outlet port is lower than an initial concentration of the initial attenuation gas mixture portion supplied into the sealed chamber through the inlet port.

5. The apparatus of claim 4,
wherein the peripheral wall of the containment structure includes an elongated hollow body, the input window is connected by way of a first mounting structure at a first end of the elongated hollow body, and the output window is connected by way of a second mounting structure at a second end of the elongated hollow body, and
wherein the inlet port is located adjacent to the first mounting structure and the outlet port is located adjacent to the second mounting structure such that the intermediate attenuation gas mixture portion flows substantially an entire length of elongated hollow body from the inlet port to the outlet port.

6. The apparatus of claim 5, wherein the containment structure comprises stainless steel and both the input window and the output window comprise uncoated calcium fluoride.

7. The apparatus of claim 5, wherein the input window and the output window are maintained at a Brewster angle relative to a longitudinal central axis of the elongated hollow body, whereby, when the initial DUV light beam section is directed parallel to the longitudinal central axis, the intermediate DUV light beam section passes through the input window and the output window with minimal Fresnel losses.

8. The apparatus of claim 5,
wherein the first mounting structure comprises an input flange and an input cap that collectively define an input opening, the input flange being fixedly connected to the first end of the elongated hollow body and the input cap being connected to the input flange,
wherein the input window is sandwiched between the input flange and the input cap and is configured such that the input window entirely covers the input opening, and
wherein the first mounting structure further includes a window gasket sandwiched between a peripheral edge of the input window and the input flange.

9. The apparatus of claim 1,
wherein the attenuation gas generation unit includes a variable ozone generator comprising:
a feed gas input mechanism configured to produce a feed gas including stable oxygen gas molecules, and
an ozone generation device configured to receive the feed gas and to generate at least a portion of the attenuation gas mixture by converting at least some of the stable oxygen gas molecules into ozone gas molecules, and
wherein the apparatus further comprises a controller configured to control a concentration of said ozone gas molecules in the attenuation gas mixture portion generated by the variable ozone generator by controlling at least one of the feed gas input mechanism and the ozone generation device.

10. The apparatus of claim 9, wherein the attenuation gas generation unit further comprises a mix gas input mechanism configured to generate a secondary gas component such that the secondary gas component combines with the attenuation gas mixture portion generated by the variable ozone generator to form the attenuation gas mixture supplied into the sealed chamber, and wherein the secondary gas component comprises at least one of oxygen gas, nitrogen gas and helium gas.

11. The apparatus of claim 1,
wherein said containment structure comprises a first containment structure and a second containment structure, the first containment structure including a first peripheral wall, a first input window and a first output window collectively surrounding a first sealed chamber, the second containment structure including a second peripheral wall, a second input window and a second output window collectively surrounding a second sealed chamber,
wherein said attenuation gas generation unit includes a first attenuation gas generation unit configured to generate and supply a first attenuation gas mixture into the first sealed chamber and a second attenuation gas generation unit configured to generate and supply a second attenuation gas mixture into the second sealed chamber, and
wherein the first and second containment structures are arranged in series along an optical path of the DUV light beam such that the DUV light beam passes to the first input window, passes from the first input window through the first sealed chamber to the first output window, passes from the first output window to the second input window, and passes from the second input window through the second sealed chamber to the second output window.

12. A DUV optical system comprising:
a DUV laser light source configured to generate a DUV light beam having an initial laser power level;
an ozone-based attenuation apparatus including a containment structure having a sealed chamber and a variable ozone generator configured to generate an attenuation gas mixture including ozone gas molecules and to supply the attenuation gas mixture into the sealed chamber, wherein the ozone-based attenuation apparatus is positioned relative to the DUV laser light source such that the DUV laser beam is directed through the sealed chamber, whereby an intermediate section of the DUV laser beam is attenuated by interaction with the ozone gas molecules located inside the sealed chamber such that a final laser power level of a final section of the DUV laser beam exiting the sealed chamber is lower than the initial laser power level;
a sensor configured to generate a measured power level value by measuring the final laser power level of the final DUV laser beam section; and
a controller configured to control the laser power level of the DUV laser beam exiting the sealed chamber thevariable ozone generator by varying a concentration of said ozone gas molecules in the attenuation gas mixture supplied into the sealed chamber in accordance with changes in the measured power level value such that achieves a target power level.

13. The system of claim 12,
wherein the containment structure including a peripheral wall, an input window and an input window collectively surrounding the sealed chamber, the input window being located on a first portion of the peripheral wall and the output window being located on a second portion of the peripheral wall,
wherein the ozone-based attenuation apparatus is positioned relative to the DUV laser light source such that an initial section of the DUV light beam having the initial laser power level is directed onto the input window, the intermediate section of the DUV laser beam passes across the sealed chamber from the input window to the output window, and the final section of the DUV laser beam is directed from the output window.

14. The system of claim 13,
wherein the attenuation gas generation unit utilizes a variable ozone generator to generate said ozone gas molecules such that the concentration of said ozone gas molecules in the attenuation gas mixture generated by the attenuation gas generation unit varies in accordance with an operating state of thevariable ozone generator,
wherein the controller is further configured to compare the measured power level value with a targeted power level value, to generate a corresponding control signal including a control value that is based on a difference between the measured power level value and the targeted power level value, and to transmit the corresponding control signal to the attenuation gas generation unit, and
wherein the attenuation gas generation unit is further configured to control the operating state of thevariable ozone generator in accordance with the control value of the corresponding control signal such that the concentration of said ozone gas molecules in the attenuation gas mixture varies in accordance with changes in the control value.

15. The system of claim 14,
wherein the containment structure further includes an inlet port and an outlet port,
wherein the ozone-based attenuation apparatus is configured such that an initial portion of the attenuation gas mixture generated by the attenuation gas generation unit is supplied to the sealed chamber through an inlet port, an intermediate portion of the attenuation gas mixture flows through the sealed chamber from the inlet port to the outlet port, and a final portion of the attenuation gas mixture flows out of the sealed chamber through the outlet port, and
wherein said interaction of the intermediate DUV light beam section with at least some of the ozone gas molecules in the sealed chamber causes a reduction in the concentration of said ozone gas molecules of the intermediate attenuation gas mixture portion such that a final concentration of the final attenuation gas mixture portion exiting the sealed chamber through the outlet port is lower than an initial concentration of the initial attenuation gas mixture portion supplied into the sealed chamber through the inlet port.

16. The system of claim 15,
wherein the peripheral wall of the containment structure includes an elongated hollow body, the input window is connected by way of a first mounting structure at a first end of the elongated hollow body, and the output window is connected by way of a second mounting structure at a second end of the elongated hollow body, and
wherein the inlet port is located adjacent to the first mounting structure and the outlet port is located adjacent to the second mounting structure such that the intermediate attenuation gas mixture portion flows substantially an entire length of elongated hollow body from the inlet port to the outlet port.

17. The system of claim 15, wherein the input window and the output window are maintained at a Brewster angle relative to a longitudinal central axis of the elongated hollow body, whereby, when the initial DUV light beam section is directed parallel to the longitudinal central axis, the intermediate DUV light beam section passes through the input window and the output window with minimal Fresnel losses.

18. The system of claim 12,
wherein the variable ozone generator comprises a feed gas input mechanism configured to generate a feed gas including stable oxygen gas molecules, and an ozone generation device configured to receive the feed gas and to generate at least a portion of the attenuation gas mixture by converting at least some of the stable oxygen gas molecules into ozone gas molecules, and
wherein the controller is further configured to control the concentration of said ozone gas molecules in the attenuation gas mixture portion generated by the variable ozone generator by controlling at least one of the feed gas input mechanism and the ozone generation device.

19. The system of claim 18, wherein the ozone-based attenuation apparatus further comprises a mix gas input mechanism configured to generate a secondary gas component such that the secondary gas component combines with the attenuation gas mixture portion generated by the variable ozone generator to form the attenuation gas mixture supplied into the sealed chamber, and wherein the secondary gas component comprises at least one of nitrogen gas and helium gas.

20. A method comprising:
supplying an attenuation gas including ozone gas molecules into a volume;
directing a deep-ultraviolet (DUV) laser light beam through the volume such that a section of the DUV laser beam located in the volume is attenuated by interaction between the DUV laser beam section and the ozone gas molecules, whereby a power level of the DUV laser beam is reduced by an attenuation amount from an initial laser power level of before entering the volume to a final power level after exiting the volume; and
controlling the attenuation amount by adjusting a concentration of said ozone gas molecules of the attenuation gas supplied into the volume.
